(19) United States
(12) Patent Application Publication
(10) Pub. No.: US 2013/0094798 A1
(43) Pub. Date: Apr. 18, 2013

(54) Monitoring Structural Shape or Deformations with Helical-Core Optical Fiber

(71) Applicants: Roger G. Duncan, Christiansburg, VA (US); Brooks A. Childers, Christiansburg, VA (US); Travis S. Hall, Radford, VA (US)

(72) Inventors: Roger G. Duncan, Christiansburg, VA (US); Brooks A. Childers, Christiansburg, VA (US); Travis S. Hall, Radford, VA (US)

(73) Assignee: BAKER HUGHES INCORPORATED, HOUSTON, TX (US)

(21) Appl. No.: 13/557,383

(22) Filed: Jul. 25, 2012

Related U.S. Application Data
(60) Provisional application No. 61/546,319, filed on Oct. 12, 2011.

(51) Int. Cl. G01B 11/16; G02B 6/34

(52) U.S. Cl. 385/13; 385/12; 356/32

(57) ABSTRACT

A method, apparatus and system for determine a parameter of a structure is disclosed. A fiber optic cable is coupled to a member. The fiber optic cable includes at least a first core helically arranged in the fiber optic cable that includes at least a first sensor and a second sensor. A first measurement related to the parameter is obtained at the first sensor, and a second measurement at the second sensor related to the parameter is obtained at the second sensor. A difference between the first and second measurements is used to determine the parameter.

### CROSS-REFERENCE TO RELATED APPLICATIONS

This application claims priority to U.S. Provisional Application Ser. No. 61/546,319,filed Oct. 12, 2011.

### BACKGROUND OF THE DISCLOSURE

In various aspects of oil exploration and production, a fiber optic cable having a plurality of optical sensors formed therein is employed to obtain information from downhole locations. The fiber optic cable typically extends from a surface location and is coupled to a member at the downhole location. A light source deployed at the surface propagates light through the fiber optic cable. The propagating light interacts with at least one of the plurality of optical sensors to produce a signal indicative of a parameter of the downhole member. The signal is then detected at the surface location. Typically, fiber optic cables include a single core along a central axis of the fiber optic cable. Such sensors are unable to give measurements relating to bending direction and torque, as well as other parameters. The present disclosure therefore provides a fiber optic cable capable of providing information beyond what can be obtained from a fiber optic cable having a central core.

### SUMMARY OF THE DISCLOSURE

In one aspect, the present disclosure provides a method of determining a parameter of a member, including: coupling a fiber optic cable to the member, the fiber optic cable having a first core helically arranged in the fiber optic cable that includes at least a first sensor and a second sensor; obtaining a first measurement at the first sensor related to the parameter; obtaining a second measurement at the second sensor related to the parameter; and determining the parameter from a difference between the first and second measurements.

In another aspect, the present disclosure provides an apparatus for determining a parameter of a member, including: a fiber optic cable configured to couple to the member, the fiber optic cable having a first core helically arranged in the fiber optic cable; a first sensor in the first core configured to provide a first measurement related to the parameter in response to a light propagating in the fiber optic cable; a second sensor in the first core configured to provide a second measurement related to the parameter in response to the light propagating in the fiber optic cable; a detector configured to detect the first signal and the second signal; and a processor configured to determine the parameter from a difference between the first and second signals.

In yet another embodiment, the present disclosure provides a system for determining a parameter of a downhole member, including: a fiber optic cable configured to couple to the member, the fiber optic cable having a first core helically arranged in the fiber optic cable; a light source configured to propagate light through the fiber optic cable; a first sensor in the first core configured to interact with the propagated light to provide a first measurement related to the parameter; a second sensor in the first core configured to interact with the propagated light to provide a second measurement related to the parameter; a detector configured to detect the first signal and the second signal; and a processor configured to determine the parameter from a difference between the first and second signals.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows an exemplary fiber optic cable of the present disclosure coupled to a member to obtain signals related to a parameter of the member;

FIG. 2 shows a fiber optic cable having exemplary sensors place at a substantially same axial location of the fiber optic cable and at different transverse locations;

FIG. 3 shows a detailed illustration of an exemplary fiber optic cable of the present disclosure;

FIG. 4 illustrates and exemplary fiber optic cable having a helical core and a central core aligned along the central axis of the fiber optic cable; and

FIG. 5 shows an exemplary fiber optic cable of the present disclosure having two helical cores.

### DETAILED DESCRIPTION OF THE DISCLOSURE

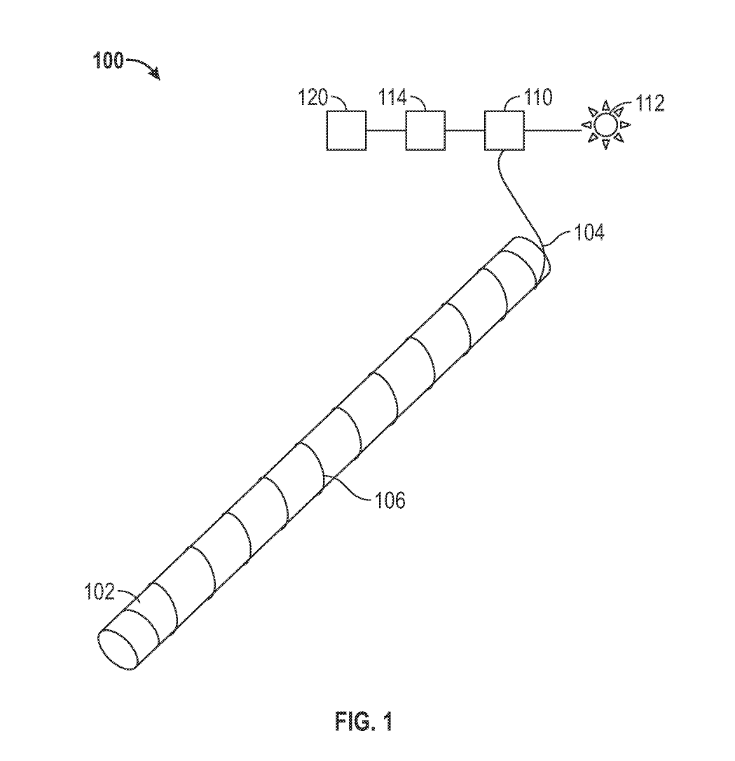

FIG. 1 shows an exemplary fiber optic cable 104 of the present disclosure coupled to a member 102 to obtain signals related to a parameter of the member. The member 102 can be used in various aspects of oil production or exploration as a member of a measurement-while-drilling tool, a borehole casing, a wireline logging device, a sandscreen, or a fiber express tube, for example. Signals obtained via the fiber optic cable 104 can be used, for example, to determine a local strain at the member as well as temperature measurements, member deformation and other parameters. These measurements can be used in various embodiments for Real Time Compaction Monitoring (RTCM), Distributed Temperature Sensing (DTS), Optical Frequency Domain Reflectometry (OFDR), and various methods using swept-wavelength interferometry.

The fiber optic cable 104 is typically wrapped around the member 102 at a determined wrapping angle and includes a plurality of sensors 106 therein. The sensors 106 in one embodiment can be optical sensors such as Fiber Bragg Gratings (FBGs) formed in a core of the fiber optic cable and which reflect light at a selected wavelength known as the central wavelength of the FBG. The central wavelength is a function of a grating period of the FBG. While the disclosure is discussed with respect to FBGs, in another embodiment, other methods of sensing a signal from the fiber optic cable that can be used to determine a parameter of the fiber optic cable or a member coupled to the fiber optic cable are considered within the scope of this disclosure. In particular, Rayleigh scattering by the fiber optic cable can be measured at various locations of the fiber optic cable in order to obtain this parameter. In order to obtain a measurement, a light from light source 112 is sent to circulator 110 which transfers the light for propagation along the fiber optic cable 104. Light reflected at a particular sensor 106 propagates back along the fiber optic cable to the circulator 110 which then sends the reflected light to be received at photodetector 114. Photodetector 114 creates an electrical signal in response to the received signal and sends the electrical signal to a processing unit 120 which determines the parameter of the member from the signal. Typically, member 102 is deployed downhole and the light source 112 and processing unit 120 are deployed at a surface location. The fiber optic cable 104 extends from the surface location to the downhole member.

Stretching or compressing the FBG of the fiber optic cable lengthens or shortens the grating period and therefore causes the FBG to reflect light at higher or lower wavelengths, respectively. By knowing the central wavelength for a relaxed or calibrated FBG, wavelength measurements obtained at the FBG can be used to determine local strains at the FBG. Typically, by coupling the fiber optic cable 104 to the member 102, each of the plurality of sensors is therefore associated with a particular location of the member 102. Wavelength measurements for a sensor can then be used to determine stretching and compression at the associated location. Taken as a whole, wavelength measurements obtained at the plurality of sensors can be used to determine deformation at the member.

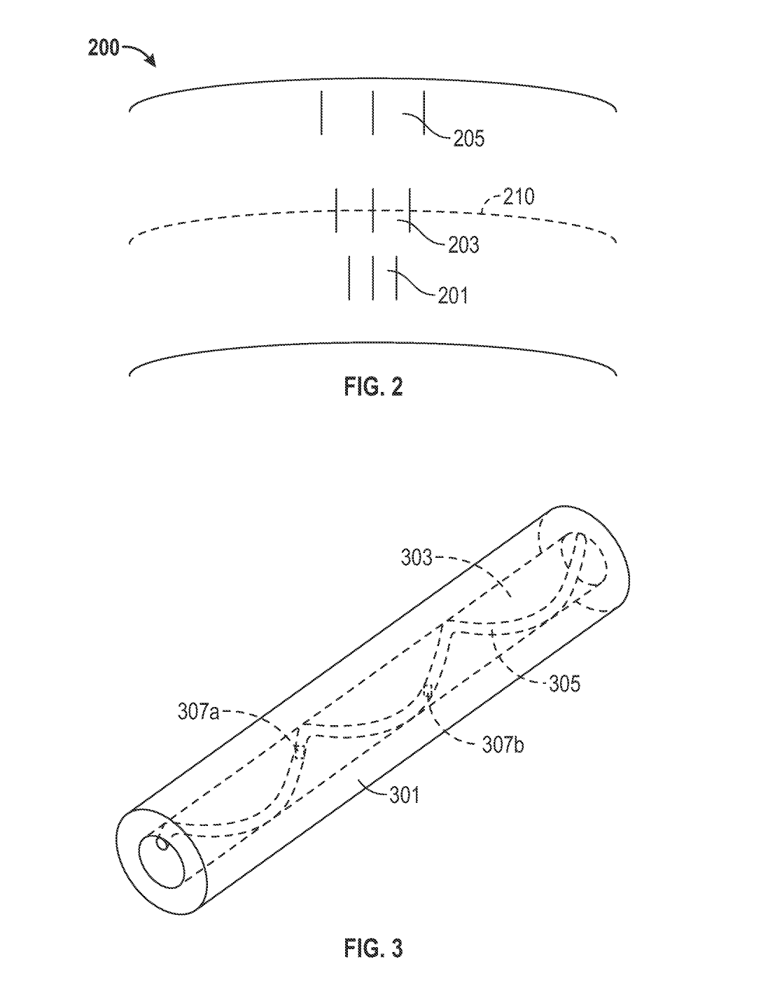

FIG. 2 shows a fiber optic cable 200 having exemplary sensors place at a substantially same axial location of the fiber optic cable and at different transverse locations. The fiber optic cable is bent for illustrative purposes. The fiber optic cable includes a neutral axis 210 that is neither compressed nor stretched by the bend. For the particular bend illustrated in FIG. 2, the part of the fiber optic cable below the neutral axis is compressed and the part of the fiber optic cable above the neutral axis is stretched. Sensors 201, 203 and 205 are FBGs that have substantially the same grating period when in a relaxed state. Sensor 201 is placed at one side of a neutral axis 210. Sensor 203 is placed on the neutral axis and sensor 205 is placed at a side of the neutral axis opposite sensor 201. The grating periods are shown as compressed (sensor 301), relaxed (sensor 303) or stretched (sensor 305) based on their location with respect to the neutral axis 210 and the bend of the fiber optic cable.

The sensors 201, 203 and 205 can be used to detect bending of the fiber optic cable. Although sensor 203 is on the neutral axis 210 and is therefore unaffected by the bend of the fiber optic cable, off-axis sensors 201 and 235 are sensitive to the bending. Measurements from any two of sensors 201, 203 and 205 can be compared to each other to detect not only the occurrence and degree of a bend, but also the bend angle direction. Thus, measurements from compressed sensor 201 can be compared to measurements from stretched sensor 205 to determine the extent and direction of the bend angle. Similarly, measurements from compressed sensor 201 can be compared to measurements from neutral sensor 203 and measurements from neutral sensor 303 can be compared to measurements from stretched sensor 205. The fiber optic cable FIG. 2 can experience additional forces, such as tensile, compressive and torsional forces, for example. Additionally, changes in temperature can affect the sensors. These additional forces and temperature effects can be detected by the exemplary sensors along with the illustrated bending force.

FIG. 3 shows a detailed illustration of an exemplary fiber optic cable of the present disclosure. The fiber optic cable includes an outer protective coating 301 surrounding an optical fiber 303. The optical fiber 303 has a helical core 305 formed therein, the helical core having a winding direction, such as clockwise or counter-clockwise. The helical core includes a plurality of sensors that are typically equally spaced along the helical core. The location of a particular sensor within the fiber optic cable can be determined by knowing the radius and the pitch angle of the helical core as well as the spacing between sensors in the helical core and a location of a reference sensor. For illustrative purposes, only two sensors 307a and 307b are shown. By virtue of being formed in the helical core 305, the plurality sensors are located off of the central axis of the fiber optic cable and at various circumferential locations.

Measurements obtained at the sensors 307a and 307b can therefore be used to determine a bend in the fiber and thus a shape of the fiber. In one embodiment, shape measurements can be obtained without attaching the fiber optic cable to a member. Additionally, the fiber optic cable can be attached to a flexible member in order to determine a shape of the member. The helical nature of the core increases a number of sensors per unit length of the optical fiber and thereby increases a measurement accuracy of a parameter of the member. Additionally, the optical fiber can be helically wrapped within a cable, wherein the cable is wrapped around the member. Thus, the cable may include a helix-with-a-helix structure. The fiber optic cable can additionally be used to obtain strain measurements at the flexible member as well as to determine bending direction and torsion at the member. Measurements at the various sensors can further be used to differentiate between bending of the member and torsion on the member. Also, for a birefringent core, the effects of birefringence on propagating light can be used to determine a torsion on the fiber optic cable or a member coupled to the fiber optic cable.

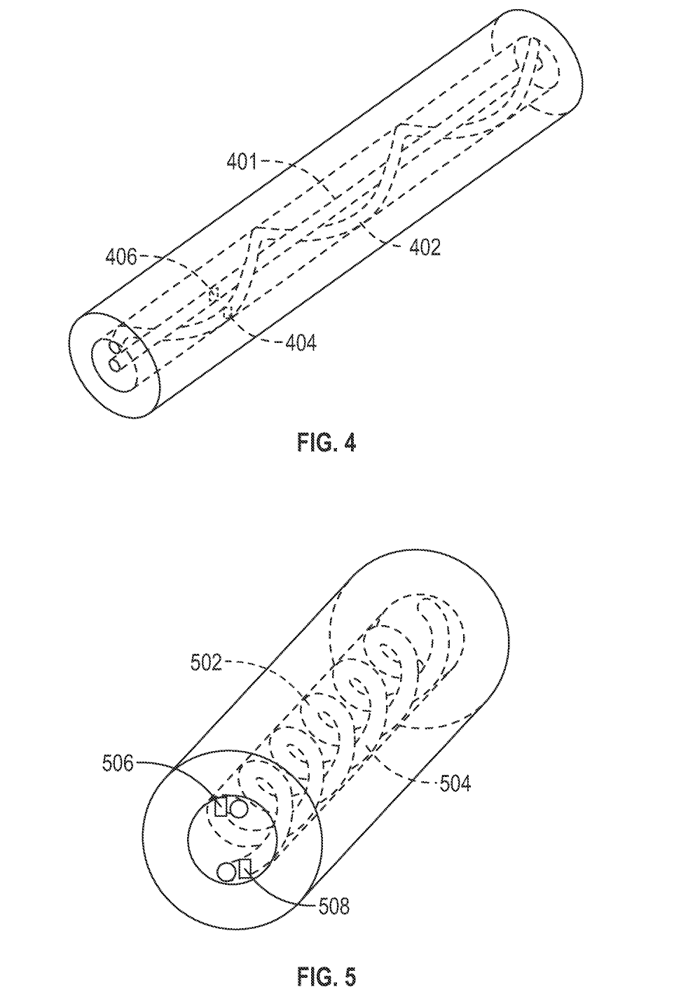

FIG. 4 illustrates another exemplary fiber optic cable of the present disclosure having a helical core 401 and a central core 402 aligned along the central axis of the fiber optic cable. Measurements can be obtained from the helical core 401 and the central 402 core at substantially same axial location of the fiber optic cable. Sensors 404 and 406 are shown on cores 401 and 402 respectively at substantially a same axial location of the fiber optic cable. In one aspect, measurements at these sensors provide measurement redundancy which can be used to improve a signal quality, for example, by improving a signal-to-noise ratio. In another aspect, the fiber optic cable of FIG. 4 can be used to compensate for the effects of temperature of FBG measurements. Measurements obtained at sensor 404 are due to temperature effects, stress on the FBG and an additional stress on the sensor due to its placement off of the neutral axis. Measurements obtained at sensor 406 are due to temperature effects and stress on the FBG. A difference between measurements at sensors 404 and 406 is therefore substantially free from temperature effects. In yet another aspect, the sensors 404 and 406 can be used to determine a magnitude and direction of a bend in the fiber optic cable as well as strains experienced at the fiber optic cable or a member coupled to the fiber optic cable.

FIG. 5 shows another exemplary fiber optic cable of the present disclosure having two helical cores. In the exemplary embodiment of FIG. 5, the two helical cores 502 and 504 having a same winding direction. Sensors 506 and 508 are disposed on cores 502 and 504 respectively and are diametrically opposed to each other. Therefore, sensor measurements from sensors 406 and 408 can be used to improved signal-to-noise ratio via measurement redundancy. Additionally, measurements at the fiber optic cable of FIG. 5 can be used to determine bend direction, deformation measurements, compressive and tensile force, torsion and temperature correction as discussed with respect to the previous embodiments. In an alternate embodiment, the fiber optic cable can have two helical cores having opposing winding directions, i.e, a first core having a clockwise winding direction and a second core having a counter-clockwise winding direction. The fiber optic cable can include two helical cores having different helix rates. Additional embodiments of the fiber optic cable include three or more helical cores. In fiber optic cables having sensors on two cores, sensor measurement can further be used to determined force components in two-dimensions. In fiber optic cables having three or more cores, sensor measurements can be used to determine force components in three-dimensions. In another embodiment, helical cores can have different winding rates.

Therefore, in one aspect, the present disclosure provides a method of determining a parameter of a member, including: coupling a fiber optic cable to the member, the fiber optic cable having a first core helically arranged in the fiber optic cable that includes at least a first sensor and a second sensor; obtaining a first measurement at the first sensor related to the parameter; obtaining a second measurement at the second sensor related to the parameter; and determining the parameter from a difference between the first and second measurements. In various embodiments, the first sensor and the second sensor are Fiber Bragg gratings and the first measurement and the second measurement are wavelengths corresponding to a strain at the member. In various embodiments, the fiber optic cable further comprises a second core having a third sensor, the method further comprising obtaining a third measurement at the third sensor related to the parameter and determining the parameter from a difference between the third measurement and at least one of the first measurement and the second measurement. The second core can be (i) along a central axis of the fiber optic cable; (ii) a helical core winding in a same helical direction as the first core; or (iii) a helical core winding in a direction counter to the winding direction of the first core, in various embodiments. The third sensor can be at substantially a same axial location of the fiber optic cable as one of the first sensor and the second sensor. Determining the parameter can include determining at least one of: (i) a shape of the member; (ii) a deformation parameter of the member; (iii) a torsion at the member; (iv) a direction of a deformation. The first and second measurements can be used to perform at least one of: (i) improving a signal-to-noise ratio of a measurement; (ii) removing an effect of temperature on a measurement; and (iii) increase a spatial resolution. The member can be a drilling tubular, a completion tubular, a borehole casing, a sandscreen and a fiber express tube in various embodiments.

In another aspect, the present disclosure provides an apparatus for determining a parameter of a member, including: a fiber optic cable configured to couple to the member, the fiber optic cable having a first core helically arranged in the fiber optic cable; a first sensor in the first core configured to provide a first measurement related to the parameter in response to a light propagating in the fiber optic cable; a second sensor in the first core configured to provide a second measurement related to the parameter in response to the light propagating in the fiber optic cable; a detector configured to detect the first signal and the second signal; and a processor configured to determine the parameter from a difference between the first and second signals. In various embodiments, the first sensor and the second sensor are Fiber Bragg gratings and the first measurement and the second measurement are wavelengths corresponding to a strain at the member. The fiber optic cable can include a second core having a third sensor configured to obtain a third measurement related to the parameter, the processor further configured to determine the parameter from a difference between the third measurement and at least one of the first measurement and the second measurement. In various embodiments, the second core is one of: (i) a core along a central axis of the fiber optic cable; (ii) a helical core winding in the same winding direction of the first core; (iii) a helical core winding counter to the winding direction of the first core. The third sensor is typically at substantially a same axial location of the fiber optic cable as one of the first sensor and the second sensor. The processor can be configured to determine at least one of: (i) a shape of the member; (ii) a deformation parameter of the member; (iii) a torsion at the member; (iv) a direction of a deformation. The processor can also be configured to use the first and second measurements to perform at least one of: (i) improving a signal-to-noise ratio of a measurement; (ii) remove an effect of temperature on a measurement; (iii) increase a spatial resolution. In various embodiments, the member is a drilling tubular, a completion tubular, a borehole casing, a sandscreen and a fiber express tube, among others.

In yet another embodiment, the present disclosure provides a system for determining a parameter of a downhole member, including: a fiber optic cable configured to couple to the member, the fiber optic cable having a first core helically arranged in the fiber optic cable; a light source configured to propagate light through the fiber optic cable; a first sensor in the first core configured to interact with the propagated light to provide a first measurement related to the parameter; a second sensor in the first core configured to interact with the propagated light to provide a second measurement related to the parameter; a detector configured to detect the first signal and the second signal; and a processor configured to determine the parameter from a difference between the first and second signals. In various embodiments, the fiber optic cable includes a second core having a third sensor configured to obtain a third measurement related to the parameter, and the processor is configured to determine the parameter from a difference between the third measurement and at least one of the first measurement and the second measurement. The processor can be configured to use the first and second measurements to perform at least one of: (i) improving a signal-to-noise ratio of a measurement; (ii) remove an effect of temperature on a measurement; (iii) increase a spatial resolution. The downhole member can be a drilling tubular, a completion tubular, a borehole casing, a sandscreen or a fiber express tube, among others.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of determining a parameter of a member, comprising:
coupling a fiber optic cable to the member, the fiber optic cable having a first core helically arranged in the fiber optic cable that includes at least a first sensor and a second sensor;
obtaining a first measurement at the first sensor related to the parameter;
obtaining a second measurement at the second sensor related to the parameter; and
determining the parameter from a difference between the first and second measurements.

2. The method of claim 1, wherein the first sensor and the second sensor are Fiber Bragg gratings and the first measurement and the second measurement are wavelengths corresponding to a strain at the member.

3. The method of claim 1, wherein the fiber optic cable further comprises a second core having a third sensor, the method further comprising obtaining a third measurement at the third sensor related to the parameter and determining the parameter from a difference between the third measurement and at least one of the first measurement and the second measurement.

4. The method of claim 3, wherein the second core is one of: (i) along a central axis of the fiber optic cable; (ii) a helical core winding in a same helical winding direction as the first core; (iii) a helical core winding in a direction counter to the winding direction of the first core; and (iv) a helical core having a helix rate different from the first core.

5. The method of claim 3, wherein the third sensor is at substantially a same axial location of the fiber optic cable as one of the first sensor and the second sensor.

6. The method of claim 1, wherein determining the parameter further comprises determining at least one of: (i) a shape of the member; (ii) a deformation parameter of the member; (iii) a torsion at the member; (iv) a direction of a deformation.

7. The method of claim 1 further comprising using the first and second measurements to perform at least one of: (i) improving a signal-to-noise ratio of a measurement; (ii) removing an effect of temperature on a measurement; and (iii) increase a spatial resolution of the determined parameter.

8. The method of claim 1, wherein the member further comprises at least one of: (i) a drilling tubular; (ii) a completion tubular; (iii) a borehole casing; (iv) a sandscreen; and (v) a fiber express tube.

9. An apparatus for determining a parameter of a member, comprising:
a fiber optic cable configured to couple to the member, the fiber optic cable having a first core helically arranged in the fiber optic cable;
a first sensor in the first core configured to provide a first measurement related to the parameter in response to a light propagating in the fiber optic cable;
a second sensor in the first core configured to provide a second measurement related to the parameter in response to the light propagating in the fiber optic cable;
a detector configured to detect the first signal and the second signal; and
a processor configured to determine the parameter from a difference between the first and second signals.

10. The apparatus of claim 9, wherein the first sensor and the second sensor are Fiber Bragg gratings and the first measurement and the second measurement are wavelengths corresponding to a strain at the member.

11. The apparatus of claim 9, wherein the fiber optic cable further comprises a second core having a third sensor configured to obtain a third measurement related to the parameter, the processor further configured to determine the parameter from a difference between the third measurement and at least one of the first measurement and the second measurement.

12. The apparatus of claim 11, wherein the second core is at least one of: (i) a core along a central axis of the fiber optic cable; (ii) a helical core winding in the same winding direction as the first core; (iii) a helical core winding counter to the winding direction of the first core.

13. The apparatus of claim 11, wherein the third sensor is at substantially a same axial location of the fiber optic cable as one of the first sensor and the second sensor.

14. The apparatus of claim 9, wherein the processor is further configured to determine at least one of: (i) a shape of the member; (ii) a deformation parameter of the member; (iii) a torsion at the member; (iv) a direction of a deformation.

15. The apparatus of claim 9, wherein the processor is further configured to use the first and second measurements to perform at least one of: (i) improving a signal-to-noise ratio of a measurement; (ii) remove an effect of temperature on a measurement; (iii) increase a spatial resolution.

16. The apparatus of claim 9, wherein the member further comprises at least one of: (i) a drilling tubular; (ii) a completion tubular; (iii) a borehole casing; (iv) a sandscreen; and (v) a fiber express tube.

17. A system for determining a parameter of a downhole member, comprising:
a fiber optic cable configured to couple to the member, the fiber optic cable having a first core helically arranged in the fiber optic cable;
a light source configured to propagate light through the fiber optic cable;
a first sensor in the first core configured to interact with the propagated light to provide a first measurement related to the parameter;
a second sensor in the first core configured to interact with the propagated light to provide a second measurement related to the parameter;
a detector configured to detect the first signal and the second signal; and
a processor configured to determine the parameter from a difference between the first and second signals.

18. The system of claim 17, wherein the fiber optic cable further comprises a second core having a third sensor configured to obtain a third measurement related to the parameter, the processor further configured to determine the parameter from a difference between the third measurement and at least one of the first measurement and the second measurement.

19. The system of claim 17, wherein the processor is further configured to use the first and second measurements to perform at least one of: (i) improving a signal-to-noise ratio of a measurement; (ii) remove an effect of temperature on a measurement; (iii) increase a spatial resolution.

20. The system of claim 17, wherein the downhole member is at least one of: (i) a drilling tubular; (ii) a completion tubular; (iii) a casing; (iv) a sandscreen; and (v) a fiber express tube.
